(19) United States
(12) Patent Application Publication
(10) Pub. No.: US 2004/0141614 A1
(43) Pub. Date: Jul. 22, 2004

(54) Data encryption apparatus and method

(75) Inventors: Yang-Lim Choi, Seongnam-si (KR); Yum-Ho Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/712,003

(22) Filed: Nov. 14, 2003

(30) Foreign Application Priority Data
Jan. 16, 2003 (KR) 2003-2965

(51) Int. Cl. H04N 7/167

(52) U.S. Cl. 380/200

(57) ABSTRACT

A technique for encrypting an audio and/or video (A/V) stream, and more particularly, an apparatus and method for encrypting an A/V stream, and an apparatus and method for generating a random number necessary for generating an encryption key used in encrypting an A/V stream are disclosed. The apparatus includes a content processor, a random number generator, an encryption key generator, and a content encryptor. The content processor receives an audio/video stream, performs a predetermined processing operation on the audio/video stream, and generates and outputs predetermined data to be used for generating a random number. The random number generator receives the predetermined data from the content processor and generates the random number. The encryption key generator receives information comprising the random number and generates an encryption key using the information. The content encryptor encrypts the audio/video stream output from the content processor using the encryption key.

This application claims the priority of Korean Patent Application No. 10-2003-0002965, filed on Jan. 16, 2003, in the Korean Intellectual Property Office, the disclosure of which is incorporated herein in its entirety by reference.

### BACKGROUND OF THE INVENTION

1. Field of the Invention

The present invention relates to a technique for encrypting an audio and/or video (A/V) stream, and more particularly, to an apparatus and method for encrypting an A/V stream, and an apparatus and method for generating a random number necessary for generating an encryption key used in encrypting an A/V stream.

2. Description of the Related Art

Encryption systems are classified into symmetric cipher (or secret key) encryption systems and asymmetric cipher (or public key) encryption systems according to a way of managing encryption keys. The symmetrical cipher encryption systems, which were mainly used before the public key encryption systems were developed, use the same key for encryption and decryption. For example, when a transmitter encrypts a plain text into a cipher text via an encryption key and an encryption algorithm and then sends the cipher text to a receiver, the receiver decrypts the cipher text into the original plain text using the same encryption key in a decryption algorithm.

The transmitter and the receiver must exchange the encryption key in a safe way prior to encrypted communications. Thus, when the transmitter and receiver have encrypted communications, a third party wanting to wiretap the encrypted communications cannot know the original plain text without the encryption key used by the transmitter and receiver. However, as the number of devices wanting encryption increases. a number of encryption keys to be managed increases. As a result, problems occur when managing and exchanging the encryption keys.

Unlike the symmetric cipher encryption systems, the asymmetric cipher encryption systems are based on a mathematical function, include a pair of keys, open one of the pair of keys to the public, and keep the other one private. Here, the key open to the public is called a public key and the key kept private is called a private key.

When the transmitter and receiver have encrypted communications using a public key, the transmitter encrypts a message into a cipher text using the public key of the receiver and transmits the cipher text to the receiver, while the receiver decrypts the cipher text into a plain text using his or her own private key. Although a person obtains the cipher text over a network, the person cannot decrypt the cipher text without a private key. Thus, since only an owner can always own a private key and does not need to transmit or inform another person of the private key, data can be safely transmitted.

A symmetric cipher is mainly used for encrypting and/or decrypting a broadcast stream. Encryption and/or decryption using the symmetric cipher can be achieved very fast, and the symmetric cipher can be safely transmitted via a restricted access system to which only authenticated users have access. In a case where an A/V stream is input to a set-top box or a personal video recorder (PVR) and is stored for future use, a receiver needs to encrypt the input A/V stream to protect a copyright and manage copies of the contents.

Accordingly, a receiver with a storage device must include an encryption and decryption engine to perform encryption and decryption. An Advanced Encryption Standard (AES) or a Triple Data Encryption Standard (TripleDES) is generally used for encryption and decryption.

A DES is an international standard block cipher which was first approved as “Data Encryption Algorithm” (DEA) by ANSI3.92 and is now prescribed as “Data Encryption Standard” (DES) in Federal Information Processing Standards Publication (FIPS PUB) 46-3. The TripleDES is a triple version of a DES cipher and is also called a DESede because two keys are used for encrypting a block three times in an encrypt-decrypt-encrypt (EDE) mode.

The AES is a next generation U.S. Encryption Standard presented by U.S. encryption-related industries. The National Institute of Standards and Technology (NIST) tested several encryption algorithms suggested by U.S. encryption-related industries and chose the AES, which is a next generation national encryption standard, as a replacement for the DES.

The stability of such an encryption and decryption system generally depends on an encryption key managing system. Also, a way of creating encryption keys is very important.

An encryption key is created from several kinds of input information. Examples of the input information include a content identification (ID), a random number, a storage ID, copy management control bits, and so forth. The randomness of values of the encryption key improves depending on how the random number is generated. There are disclosed several methods of generating a random number. Among these, one method is to easily generate a random number at a low cost. However, since the generated random number is a pseudo random number, its reliability is low. In other words, the generated random number is incomplete and reappears after a long cycle. Since the cycle of the generated random number becomes long depending on the number of bits that are used to generate the random number, the randomness of the random number improves.

There is another method of generating a random number using a physical phenomenon. Examples of this method include: generating a random number using thermal noise of an apparatus, generating a random number using noise from a hard disc, generating a random number by sampling a high frequency signal as an unstable low frequency clock signal, generating a random number by applying a backward bias voltage to a p-n junction of semiconductor silicon, generating a random number using several phenomena of quantum mechanics, and the like. Such a physical phenomenon can contribute to generating a precise random number. However, since this is very complicated, a specific apparatus is required and costs increase.

### SUMMARY OF THE INVENTION

The present invention provides an encryption apparatus and method for encrypting an input A/V stream in an A/V processing system or an A/V storage system.

The present invention also provides an apparatus and method for generating a random number used for generating a symmetric cipher used in implementing encryption.

The present invention also provides an apparatus and method for generating a random number more stably and more cost effectively than a conventional random number generating algorithm.

According to an exemplary aspect of the present invention, there is provided an encryption apparatus including: a content processor that receives an audio/video stream, performs a predetermined processing operation on the audio/video stream, and generates and outputs predetermined data to be used for generating a random number; a random number generator that receives the predetermined data from the content processor and generates the random number; an encryption key generator that receives information comprising the random number and generates an encryption key using the information; and a content encryptor that encrypts the audio/video stream output from the content processor using the encryption key.

According to another exemplary aspect of the present invention, there is provided an apparatus for generating a random number. The apparatus includes: a content processor that receives an audio/video stream, and generates and outputs statistical feature information of the audio/video stream; and a random number generator that receives the statistical feature information and generates a random number using the statistical feature information.

According to still another exemplary aspect of the present invention, there is provided an encryption method comprising: receiving an audio/video stream, performing a predetermined processing operation on the audio/video stream, and generating and outputting predetermined data to be used for generating a random number; receiving the predetermined data and generating the random number; receiving information comprising the random number and generating an encryption key using the information; and encrypting the audio/video stream, which has undergone the predetermined processing operation, using the encryption key.

According to yet another exemplary aspect of the present invention, there is provided a method of generating a random number. The method includes: receiving an audio/video stream, and generating and outputting statistical feature information of the audio/video stream; and receiving the statistical feature information and generating a random number using the statistical feature information.

According to yet another exemplary aspect of the present invention, there is provided a computer-readable recording medium on which a program is recorded to execute the encryption method.

According to yet another exemplary aspect of the present invention, there is provided a computer-readable recording medium on which a program is recorded to execute the method of generating the random number.

### BRIEF DESCRIPTION OF THE DRAWINGS

The above and other exemplary features and advantages of the present invention will become more apparent by describing in detail various illustrative, non-limiting embodiments thereof with reference to the attached drawings in which:

FIG. 1 is a block diagram of an apparatus for encrypting and outputting an A/V stream;

FIG. 2 is a view for explaining a method of generating a random number using a linear feedback shift register (LFSR);

FIG. 3 is a block diagram of an apparatus for encrypting an A/V stream, according to the present invention; and

FIG. 4 is a flowchart for explaining a method of encrypting an A/V stream, according to the present invention.

### DETAILED DESCRIPTION OF THE INVENTION

Hereinafter, illustrative, non-limiting embodiments of the present invention will be described in detail with reference to the attached drawings.

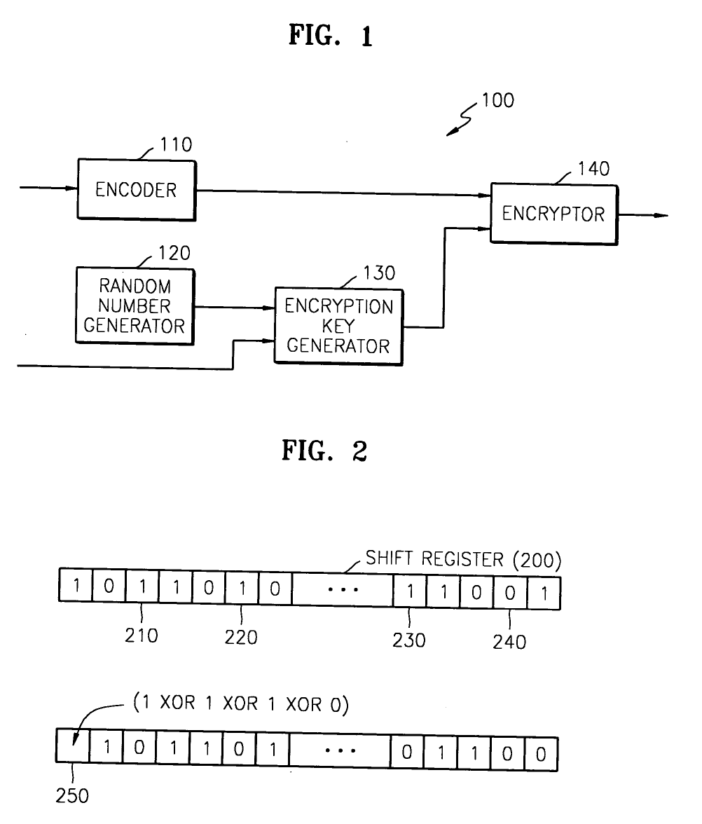

FIG. 1 is a block diagram of an apparatus for encrypting and outputting an A/V stream. Referring to FIG. 1, an A/V stream encrypting and outputting apparatus 100 includes an encoder 110, a random number generator 120, an encryption key generator 130, and an encryptor 140.

The encoder 110 receives and encodes an A/V stream using an encoding method according to Moving Picture Experts Group (MPEG) standards.

The random number generator 120 generates a random number using a predetermined algorithm. The predetermined algorithm may be a random number generating algorithm using a linear feedback shift register (LFSR), a Cellular Automata algorithm, or the like.

FIG. 2 is a view for explaining a method of generating a random number using an LFSR. Referring to FIG. 2, in the random number algorithm using the LFSR, an initial value is stored in a shift register 200 with a predetermined size. Next, a Boolean exclusive OR (XOR) operation is performed on values stored in specific bits 210 through 240 of the shift register 200 to obtain a new value. In FIG. 2, since the Boolean XOR operation is performed on the bits 210 and 220, and the bits 230 and 240, the new value is “1”. When the shift register 200 is shifted, a bit 250 at the leftmost position of the shift register 200 becomes empty. Thus, the new value is stored in the bit 250. As a result, the initial value stored in the shift register 200 is updated as the new value. In other words, a new value can be continuously created using the Boolean XOR operation by shifting the shift register 200 one bit by one bit so as to generate a random number. The generated random number is a pseudo random number. However, when the initial value and the specific bits 210 through 240 are properly set, true randomness can be obtained. Here, the positions of the specific bits 210 through 240 may be randomly determined.

Instead of the random number generating method using the LFSR, a method of generating a more precise random number using a physical phenomenon may be adopted or a combination of the two methods may be employed.

The encryption key generator 130 receives the random number from the random number generator 120 and several kinds of input information to generate an encryption key. Examples of the several kinds of information may include a content ID, a storage ID, copy management control bits, and so forth. The encryption key may be generated according to several methods. For example, the encryption key may be generated by performing a Boolean XOR operation on all input information or by performing a specific Boolean operation on random bits. As long as the encryption key cannot be predicted by unauthenticated persons, the encryption key may be generated using any other method.

The encryptor 140 receives the encoded A/V stream from the encoder 110, encrypts the encoded A/V stream using the encryption key generated by the encryption key generator 130, and outputs the encrypted A/V stream.

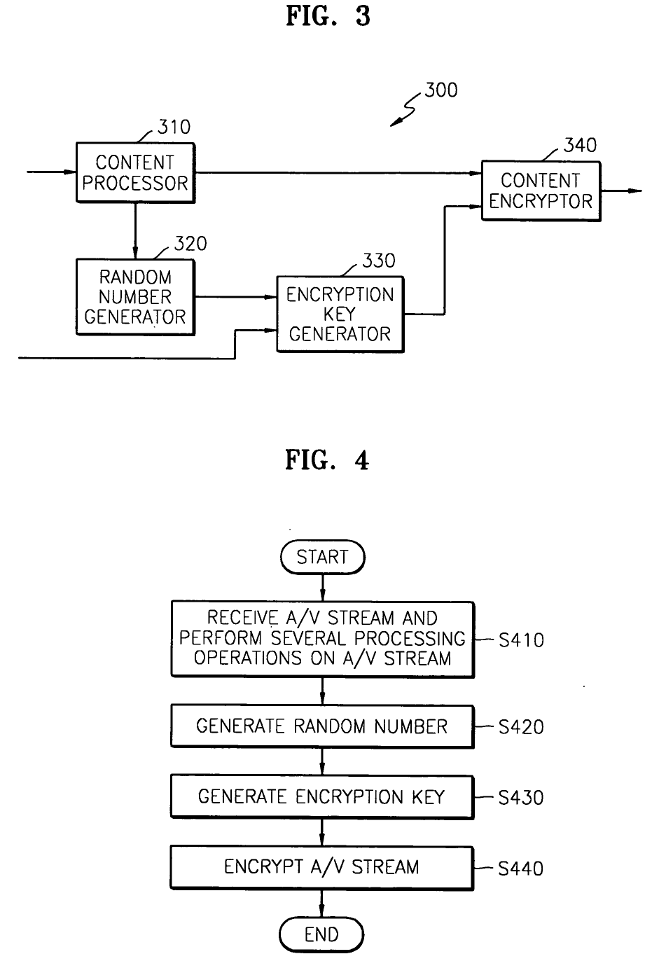

FIG. 3 is a block diagram of an apparatus for encrypting an A/V stream, according to the present invention. Referring to FIG. 3, an A/V stream encrypting apparatus 300 includes a content processor 310, a random number generator 320, an encryption key generator 330, and a content encryptor 340.

The content processor 310 receives an A/V stream and performs several processing operations on the A/V stream. Information used for generating a random number may vary depending on which processing operations are performed on the received A/V stream. In other words, the random number is generated using statistical features which are generated as by-products when the content processor 130 performs its original function, i.e., processes the A/V stream. The statistical features are, for example, color distribution information, motion estimation information, noise estimation information of a macroblock, and so on. In other words, the content processor 310 must transmit the information used for generating the random number to the random number generator 320. Here, the information may be generated using several methods which will be explained below.

One of the above methods is to use the least significant 1 bit of a motion vector (MV) generated in a motion estimation (ME) module. The MV is generated in each macroblock and the least significant 1 bit of each of the MVs is sequentially stored in a shift register with a predetermined size. In a case where a 128-bit shift register is used, the least significant 1 bit of an MV generated in a first macroblock is stored in the 128-bit shift register, the 128-bit shift register is shifted, and the least significant 1 bit of an MV generated in a second macroblock is stored in the 128-bit shift register. Accordingly, the least significant 1 bit of an MV is continuously stored in the 128-bit shift register so as to determine all values of the 128-bit shift register. Thereafter, the values stored in the shift register are output to the random number generator 320 at a point in time when the random number is required to be generated.

Another method is to use the least significant 1 bit of sum of absolute difference (SAD) information generated in an ME module. In the same way as the above method, the least significant 1 bit of SAD information is sequentially stored in a shift register with a predetermined size and then output to the random number generator 320 at a point in time when the random number is required to be generated.

There is also another method of using the least significant 1 bit of variance information generated in a Motion Compensated-Discrete Cosine Transform (MC-DCT) module. In this method, the least significant 1 bit of variance information is sequentially stored in a shift register with a predetermined size and then output to the random number generator 320 at a point in time when the random number is required to be generated.

The random number generator 320 receives the information, for example as generated using one of the above-described methods, from the content processor 310 and then generates the random number using the information. The random number may also be generated using several methods. For example, when the information received from the content processor 310 is R and the random number generated by the random number generator 320 is A, a Boolean XOR operation may be performed on the information R and the random number A, and the result of the Boolean XOR operation may be output as a new random number. The random number A may be generated by employing a conventional random number generating algorithm, such as an algorithm using the LFSR or the Cellular Automata algorithm.

The encryption key generator 330 receives the random number generated by the random number generator 320 and several other kinds of information and then generates an encryption key. Examples of the several other kinds of information include a content ID, a storage ID, copy management control bits, and so forth. The encryption key may be generated using various methods. For example, the encryption key may be generated by performing a Boolean XOR operation on all input information or by performing a specific Boolean operation on random bits. As long as the encryption key cannot be predicted by unauthenticated persons, the encryption key may be generated using any other method.

The content encryptor 340 encrypts the A/V stream output from the content processor 310 using the encryption key generated by the encryption key generator 330 and then outputs the encrypted A/V stream.

FIG. 4 is a flowchart of a method of encrypting an A/V stream, according to the present invention. Referring to FIG. 4, in step S410, an A/V stream is received and several processing operations are performed on the A/V stream. Information used for generating a random number may vary depending on which processing operations are performed on the received A/V stream. In other words, the random number is generated using statistical features which are generated as by-products when the A/V stream is processed. Here, the information may be generated using various methods, as explained below.

One exemplary method is to use the least significant 1 bit of a motion vector (MV) generated in a motion estimation (ME) module. The MV is generated in each macroblock and the least significant 1 bit of each of the MVs is sequentially stored in a shift register with a predetermined size. In a case where a 128-bit shift register is used, the least significant 1 bit of an MV generated in a first macroblock is stored in the 128-bit shift register, the 128-bit shift register is shifted, and the least significant 1 bit of an MV generated in a second macroblock is stored in the 128-bit shift register. Accordingly, the least significant 1 bit of an MV is continuously stored in the 128-bit shift register so as to determine all values of the 128-bit shift register. Thereafter, the values stored in the shift register are read to generate the random number when the random number is required to be generated.

Another exemplary method is to use the least significant 1 bit of sum of absolute difference (SAD) information generated in an ME module. In the same way as the above method, the least significant 1 bit of SAD information is sequentially stored in a shift register with a predetermined size and then read to generate the random number when the random number is required to be generated.

Yet another exemplary method is to use the least significant 1 bit of variance information generated in a Motion Compensated-Discrete Cosine Transform (MC-DCT) module. In this method, the least significant 1 bit of variance information is sequentially stored in a shift register with a predetermined size and then read to generate the random number when the random number is required to be generated.

In step S420, the information, for example as generated using one of the above-described methods, is received, and then the random number is generated using the information. The random number may also be generated using several methods. For example, when the information received from the content processor 310 is R and the random number generated by the random number generator 320 is A, a Boolean XOR operation may be performed on the information R and the random number A, and the result of the Boolean XOR operation may be output as a new random number. The random number A may be generated by employing a conventional random number generating algorithm, such as an algorithm using the LFSR or the Cellular Automata algorithm.

In step S430, the random number generated in step S420 and several other kinds of information are received to generate an encryption key. Examples of the several other kinds of information include a content ID, a storage ID, copy management control bits, and so forth. The encryption key may be generated using various methods. For example, the encryption key may be generated by performing a Boolean XOR operation on all input information or by performing a specific Boolean operation on random bits. As long as the encryption key cannot be predicted by unauthenticated persons, the encryption key may be generated using any other method.

In step S440, the A/V stream is encrypted using the encryption key generated in step S430 and then output.

As described above, in an encrypting apparatus and method according to the present invention, since video data is temporally and spatially random and a random number is generated using the random video data, the generated random number can be truly random. Thus, a generated encryption key is hardly correlated with any other information and is unpredictable. As a result, the safety of the generated encryption key is increased.

In addition, a random number can be generated using each A/V stream. Thus, when input A/V streams are different, generated encryption keys are also different. Therefore, although a hacker succeeds in hacking an encryption key generator of a system, the generated encryption keys can be protected from hacking. In other words, although the hacker knows an internal algorithm of the encryption key generator, the encryption keys are generated using information generated by a content processor and thus cannot be decrypted. Accordingly, even though the hacker is able to know a pseudo random number generator in the encryption key generator, the hacker cannot decrypt the encrypted A/V streams.

Moreover, since the encryption apparatus and method of the present invention are based on an algorithm, costs can be reduced. In other words, the random number can be generated using either software or hardware, which can realize the encryption method of the present invention, without using a specific device.

The present invention can be realized as a computer-readable code on a computer-readable recording medium. Computer-readable recording media include recording apparatuses storing computer-readable data. Computer-readable recording media include ROMs, RAMs, CD-ROMs, magnetic tapes, floppy discs, optical data storage devices, and carrier waves (e.g., transmission over the Internet). The computer-readable recording media can also store and execute a computer-readable code in computers connected via a network in a distributed manner.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An encryption apparatus comprising:
a content processor that receives an audio/video stream, performs one or more predetermined processing operations on the audio/video stream, and generates and outputs predetermined data to be used for generating a random number;
a random number generator that receives the predetermined data from the content processor and generates the random number;
an encryption key generator that receives information comprising the random number and generates an encryption key using the information; and
a content encryptor that encrypts the audio/video stream output from the content processor using the encryption key.

2. The encryption apparatus of claim 1, wherein the content processor compresses the received audio/video stream as MPEG video.

3. The encryption apparatus of claim 2, wherein the content processor generates the predetermined data based on statistical features of the audio/video stream that are generated when compressing the received audio/video stream as the MPEG video.

4. The encryption apparatus of claim 3, wherein the statistical features include at least one of color distribution information, motion estimation information, and noise estimation information of a macroblock that are generated when compressing the received audio/video stream as the MPEG video.

5. The encryption apparatus of claim 1, wherein the content processor generates and outputs the predetermined data to be used to generate the random number, based on motion vector information that is generated during a motion estimation processing operation.

6. The encryption apparatus of claim 5, wherein the predetermined data is a least significant 1 bit of a motion vector that is generated during the motion estimation processing operation in a macroblock and then stored in a shift register and a plurality of other least significant 1 bits of motion vectors that are generated in subsequent macroblocks and then sequentially stored in the shift register, by shifting the shift register bit by bit, the stored least significant 1 bits being output when the generation of the random number is requested.

7. The encryption apparatus of claim 1, wherein the content processor generates and outputs the predetermined data to be used to generate the random number, based on the sum of absolute difference information that is generated during a motion estimation processing operation.

8. The encryption apparatus of claim 7, wherein the predetermined data is a least significant 1 bit of the sum of absolute difference information that is generated during the motion estimation processing operation in a macroblock and then stored in a shift register and a plurality of other least significant 1 bits of the sum of absolute difference information that are generated in subsequent macroblocks and then sequentially stored in the shift register, by shifting the shift register bit by bit, the stored least significant 1 bits being output when the generation of the random number is requested.

9. The encryption apparatus of claim 1, wherein the content processor generates predetermined data to be used to generate the random number, based on variance information that is generated during a Motion Compensated-Discrete Cosine Transform processing operation.

10. The encryption apparatus of claim 9, wherein the predetermined data is a least significant 1 bit of variance information that is generated during the Motion Compensated-Discrete Cosine Transform and then stored in a shift register and a plurality of other least significant 1 bits of variance information that are generated subsequently and then sequentially stored in the shift register, by shifting the shift register bit by bit, the stored least significant 1 bits being output when the generation of the random number is requested.

11. The encryption apparatus of claim 1, wherein the random number generator performs a predetermined operation on the predetermined data received from the content processor and the random number, which is generated by the random number generator using a predetermined algorithm, to generate a new random number.

12. The encryption apparatus of claim 11, wherein the predetermined operation is a Boolean XOR operation.

13. The encryption apparatus of claim 11, wherein the predetermined algorithm is one of a random number generating algorithm using a linear feedback shift register and a Cellular Automata algorithm.

14. The encryption apparatus of claim 1, wherein the encryption key generator receives content identification information, storage identification information, and copy management control bit information in addition to the random number generated by the random number generator and performs a predetermined operation on the random number, the content identification information, the storage identification information, and the copy management control bit information to generate the encryption key.

15. The encryption apparatus of claim 14, wherein the predetermined operation is one of a Boolean XOR operation that is performed on all bits of the random number, the content identification information, the storage identification information, and the copy management control bit information and a Boolean XOR operation that is performed on predetermined random bits of the random number, the content identification information, the storage identification information, and the copy management control bit information.

16. An apparatus for generating a random number, the apparatus comprising:
a content processor that receives an audio/video stream, and generates and outputs statistical feature information of the audio/video stream; and
a random number generator that receives the statistical feature information and generates a random number using the statistical feature information.

17. The apparatus of claim 16, wherein the statistical feature information is one of motion vector information that is generated during a motion estimation, the sum of absolute difference information that is generated during the motion estimation, and variance information that is generated during a Motion Compensated-Discrete Cosine Transform.

18. The apparatus of claim 16, wherein the statistical feature information are a least significant 1 bit of a motion vector that is generated during the motion estimation in a macroblock and then stored in a shift register and a plurality of other least significant 1 bits of motion vectors that are generated in subsequent macroblocks and then sequentially stored in the shift register, by shifting the shift register bit by bit, the stored least significant 1 bits being output when the generation of the random number is requested.

19. The apparatus of claim 16, wherein the statistical feature information are a least significant 1 bit of the sum of absolute difference information that is generated during motion estimation in a macroblock and then stored in a shift register and a plurality of other least significant 1 bits of the sum of absolute difference information that are generated in subsequent macroblocks and then sequentially stored in the shift register, by shifting the shift register bit by bit, the stored least significant 1 bits being output when the generation of the random number is requested.

20. The apparatus of claim 16, wherein the statistical feature information are a least significant 1 bit of variance information that is generated during the Motion Compensated-Discrete Cosine Transform and then stored in a shift register and a plurality of other least significant 1 bits of variance information that are generated subsequently and then sequentially stored in the shift register, by shifting the shift register bit by bit, the stored least significant 1 bits being output when the generation of the random number is requested.

21. An encryption method comprising:
receiving an audio/video stream, performing one or more predetermined processing operations on the audio/video stream, and generating and outputting predetermined data to be used for generating a random number;
receiving the predetermined data and generating the random number;
receiving information comprising the random number and generating an encryption key using the information; and
encrypting the audio/video stream, which has undergone the one or more predetermined processing operations, using the encryption key.

22. The encryption method of claim 21, wherein the one or more predetermined processing operations include compressing the received audio/video stream as MPEG video.

23. The encryption method of claim 22, wherein the predetermined data is generated based on at least one of color distribution information, motion estimation information, and noise estimation information of a macroblock, which are statistical features of the audio/video stream that are generated when compressing the received audio/video stream as the MPEG video.

24. The encryption method of claim 21, wherein in the generating and outputting of the predetermined data, the predetermined data to be used for generating the random number is generated and output using at least one of motion vector information that is generated during a motion estimation, the sum of absolute difference information that is generated during the motion estimation, and variance information that is generated during a Motion Compensated-Discrete Cosine Transform.

25. The encryption method of claim 24, wherein in the generating and outputting of the predetermined data, one of a least significant 1 bit of motion vector information that are generated in each macroblock during the motion estimation, a least significant 1 bit of the sum of absolute difference information that are generated in each macroblock during the motion estimation, and a least significant 1 bit of variance information that is generated during a Motion Compensated-Discrete Cosine Transform in each macroblock, is sequentially stored in the shift register, by shifting a shift register of a predetermined size, and output when the generation of the random number is requested.

26. The encryption method of claim 21, wherein the random number is generated by performing a predetermined operation on the predetermined data and a previously generated random number that was generated using a predetermined random number generating algorithm.

27. The encryption method of claim 26, wherein the predetermined random number generating algorithm is one of a random number generating algorithm using a linear feedback shift register and a Cellular Automata algorithm.

28. The encryption method of claim 21, wherein the encryption key is generated by receiving the random number, content identification information, storage identification information, and copy management control bit information and performing a predetermined operation on the random number, the content identification information, the storage identification information, and the copy management control bit information.

29. The encryption method of claim 28, wherein the predetermined operation is one of a Boolean XOR operation that is performed on all bits of the random number, the content identification information, the storage identification information, and the copy management control bit information and a Boolean XOR operation that is performed on predetermined random bits of the random number, the content identification information, the storage identification information, and the copy management control bit information.

30. A method of generating a random number, the method comprising:
receiving an audio/video stream, and generating and outputting statistical feature information of the audio/video stream; and
receiving the statistical feature information and generating a random number using the statistical feature information.

31. The method of claim 30, wherein the statistical feature information is one of motion vector information that is generated during a motion estimation, the sum of absolute difference information that is generated during the motion estimation, and variance information that is generated during a Motion Compensated-Discrete Cosine Transform.

32. The method of claim 30, wherein the statistical feature information are a least significant 1 bit of a motion vector that is generated during the motion estimation in a macroblock and then stored in a shift register and a plurality of other least significant 1 bits of motion vectors that are generated in subsequent macroblocks and then sequentially stored in the shift register, by shifting the shift register bit by bit, the stored least significant 1 bits being output when the generation of the random number is requested.

33. The method of claim 30, wherein the statistical feature information are a least significant 1 bit of the sum of absolute difference information that is generated during motion estimation in a macroblock and then stored in a shift register and a plurality of other least significant 1 bits of the sum of absolute difference information that are generated in subsequent macroblocks and then sequentially stored in the shift register, by shifting the shift register bit by bit, the stored least significant 1 bits being output when the generation of the random number is requested.

34. The method of claim 30, wherein the statistical characteristic information are a least significant 1 bit of variance information that is generated during the Motion Compensated-Discrete Cosine Transform and then stored in a shift register and a plurality of other least significant 1 bits of variance information that are generated subsequently and then sequentially stored in the shift register, by shifting the shift register bit by bit, the stored least significant 1 bits being output when the generation of the random number is requested.

35. A computer-readable recording medium on which a program is recorded to execute the method of claim 21 in a computer.

36. A computer-readable recording medium on which a program is recorded to execute the method of claim 30 in a computer.
